(19) United States
(12) Patent Application Publication
(10) Pub. No.: US 2008/0118706 A1
(43) Pub. Date: May 22, 2008

(54) Substrate

(76) Inventor: Jurgen Schulz-Harder, Luaf (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/791,657

(22) PCT Filed: Sep. 23, 2005
(86) PCT No.: PCT/DE05/01682

§ 371 Date: May 25, 2007

(30) Foreign Application Priority Data
Nov. 29, 2004 (DE) 10 2004 057 683.1
Dec. 2, 2004 (DE) 10 2004 058 335.8

(51) Int. Cl. B32B 3/10; B32B 5/00; B32B 5/16; B32B 17/00; B32B 18/00

(52) U.S. Cl. 428/138; 428/221; 428/323; 428/325

(57) ABSTRACT

The invention relates to a substrate with a metallic carrier layer, at least one insulating layer which is provided on a surface side of the carrier layer and which is produced with the aid of a polymer material or polymer component, in addition to metallization which is provided on a partial area of the insulating layer and electrically separated from the carrier layer by means thereof. The insulating layer contains at least one other component which, as a distance-maintaining component, defines the thickness of the insulating layer and is made of a dimensionally stable inorganic material.

### BACKGROUND OF THE INVENTION

The invention relates to a substrate and in particular to a substrate that is suitable for use as a printed circuit board for electric circuits.

Substrates are known in the art that consist of a metallic base plate or base layer, which is provided on at least one surface with an insulating layer, on which a metallization is applied, for example in the form of a copper foil. The latter can be structured to form contact surfaces, conductor strip conductors, etc. using standard technologies, for example masking and etching. The metallic base layer or base plate gives such a substrate sufficient mechanical stability, and also provides for optimum cooling of the components provided on the printed circuit board. A further essential advantage of these substrates consists in the possibility of manufacturing them very inexpensively.

It is an object of the invention is to present a substrate of this type with improved properties.

### SUMMARY OF THE INVENTION

A special feature of the substrate according to the invention is that the insulating layer, in addition to the at least one polymer component, also features a distance-maintaining component, which defines the distance between the at least one metallization and a surface bearing the insulating layer and therefore the thickness of the insulating layer. This distance-maintaining component is made of a dimensionally stable, electrically non-conductive material, preferably of an inorganic material.

The design according to the invention ensures a consistent thickness of the insulating layer, and simultaneously the economical manufacture of the substrate. In particular, the metallization is prevented from bearing directly against the metallic base layer as a result of production errors. The design according to the invention therefore achieves constant or essentially constant thermal conductivity and also a constant or nearly constant dielectric strength of the substrate over the entire surface of said substrate.

### DETAILED DESCRIPTION OF THE DRAWINGS

The invention is explained below in more detail based on exemplary embodiments with reference to the drawings, wherein:

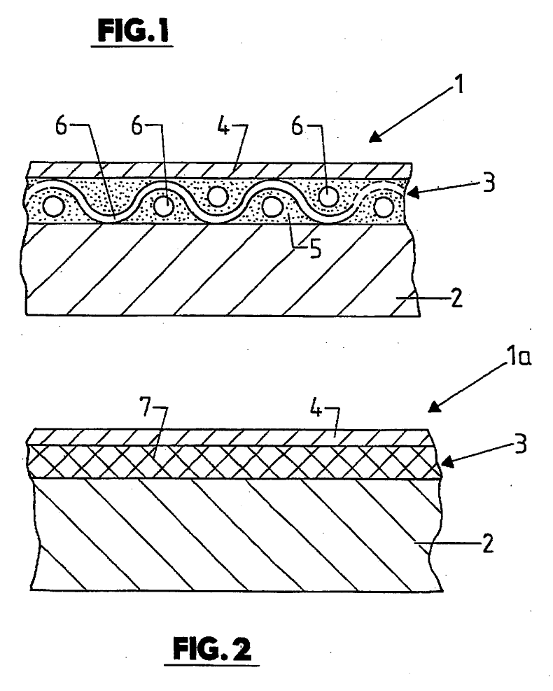

FIG. 1-4 show simplified views in cross section of different embodiments of the substrate according to the invention;

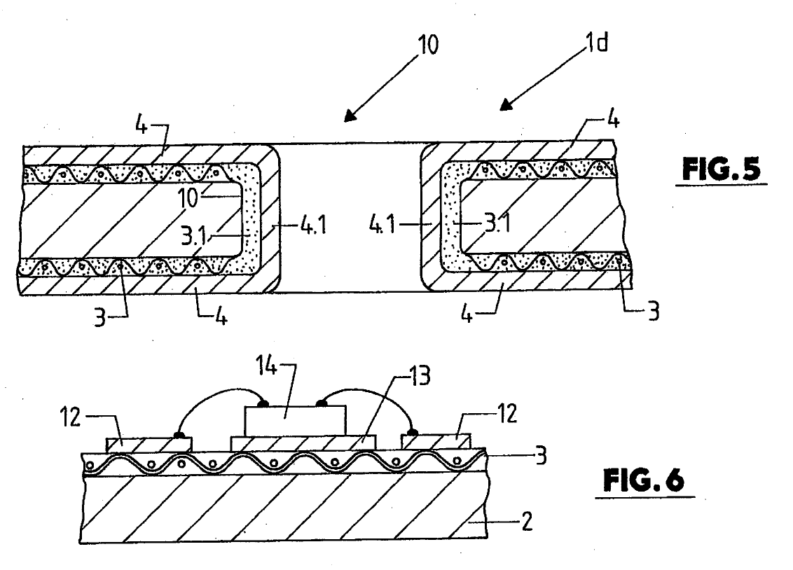

FIG. 5 shows an enlarged view in cross section of a substrate according to the invention in the area of a through-hole contact;

FIG. 6 shows the substrate of FIG. 1 as a printed circuit board for an electric circuit;

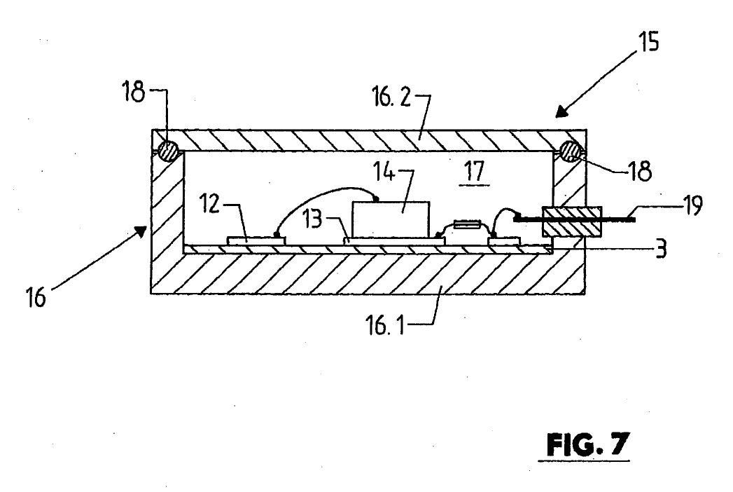

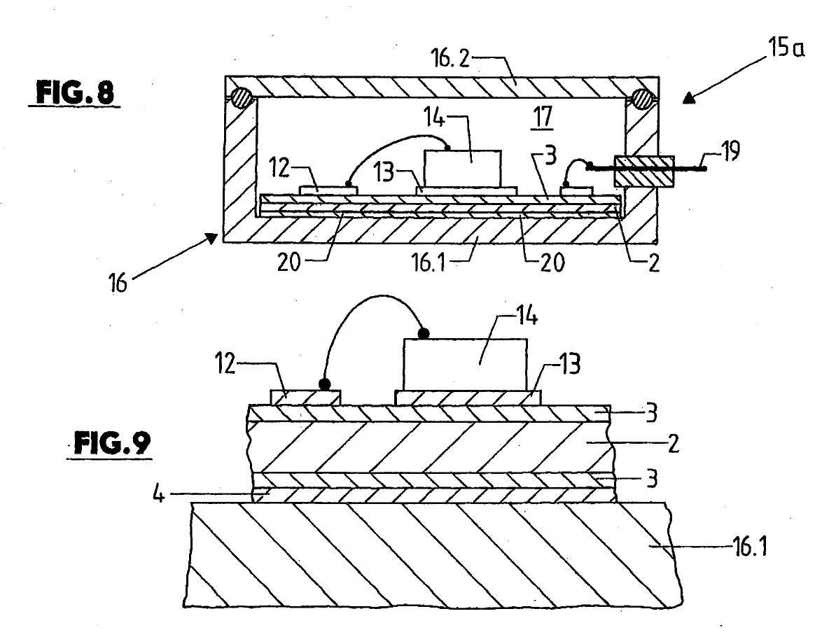

FIG. 7-8 show a module in cross section;

FIG. 9 shows a partial view of the module of FIG. 8 in a further embodiment; and

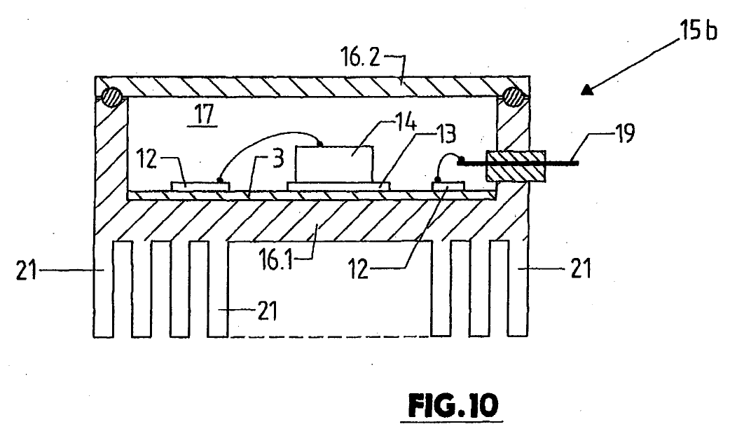

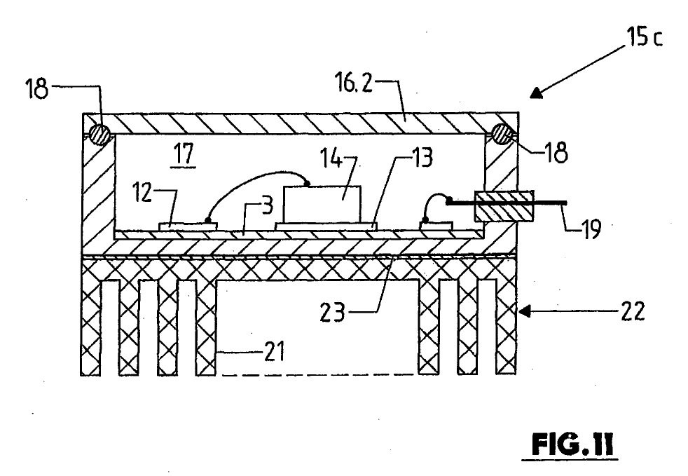

FIG. 10-11 show a partial view of modules according to the invention.

### DETAILED DESCRIPTION OF THE INVENTION

The substrate 1 shown in a simplified partial view in cross section in FIG. 1 consists essentially of a metal plate or metal or base layer 2, which in the depicted embodiment is provided on one surface or surface side with an insulating layer 3 and above that layer a metallization 4. The metallization 4, which is formed for example by a metal foil, has a much smaller thickness than the base layer 2. The thickness of the insulating layer 3 in this embodiment is also greater than the thickness of the metallization 4 but smaller than the thickness of the metal layer 2. When the substrate 1 is used as a printed circuit board for electric circuits or modules, the metallization 4 is structured using a suitable technology, for example masking and/or etching technology.

A special feature of the substrate 1 consists in the fact that the insulating layer 3 is made of at least two components, namely
of a first component defining a defined distance between the base layer 2 and the metallization 4 and therefore a defined, constant thickness or essentially constant thickness for the insulating layer 3 over the entire surface of the substrate 1, said first component being a dimensionally stable and electrically insulating material and functioning as a spacer element, and
of a second, polymer component, which fills the volume of the insulating layer 3 not occupied by the spacer element and also serves to connect the metallization 4 with the base layer 2.

The second component is a suitable polymer or synthetic material 5. The first component in the depicted embodiment is a fabric 6 made of a dimensionally stable inorganic material, for example a web made of glass fibers and/or ceramic fibers.

Suitable materials for the base layer 2 are, for example, aluminum, aluminum alloys, copper, copper alloys or other metals with good thermal conducting properties. Suitable materials for the metallization 4 are especially such metals that are normally used for printed circuit boards, in particular also copper or copper alloys.

The advantage of the substrate 1 consists in the fact that it can be manufactured inexpensively and that due to the first component or the corresponding fabric 6, a defined, constant distance between the base layer 2 and the metallization 4 exists, so that a constant, uniquely clearly defined thermal transfer between the metallization 4 and the base layer 2, which is provided for example with a cooler, exists especially for all areas of the substrate. For components arranged on a printed circuit board manufactured from the substrate 1, this results in defined and reproducible conditions for the thermal transfer and cooling. Also, the special design of the insulating layer 3 reliably prevents the formation of areas or defective spots during the manufacture of the substrate 1 where the metallization 4 is in direct contact with the base layer 2. The defined thickness of the insulating layer 3 also produces a constant, clearly defined dielectric strength between the base layer 2 and the metallization 4 over the entire surface of the substrate 1.

The two components 5 and 6 of the insulating layer 3 are formed, for example, from a prepreg material, i.e. from a fiber fabric, which is already impregnated with a polymer material, e.g. with a thermoplastic material. The manufacture of the substrate 1 is then effected for example in the manner that the insulating layer 3 or the material forming said insulating layer is applied to the base layer 2 and the foil forming the metallization 4 is then placed on top and that this series of layers is bonded to the substrate 1 by means of heating and pressing.

FIG. 2 shows in a depiction similar to FIG. 1 as a further embodiment a substrate 1a, which differs from the substrate 1 essentially only in that the insulating layer 3 there between the base layer 2 and the metallization 4 contains as the first component a fibrous web, which is again formed from a suitable, dimensionally stable inorganic material, for example again of glass fibers and/or ceramic fibers. In addition to this component, the insulating layer 3 again features the second, polymer component, which serves for example to connect the metallization, insulating layer and base layer.

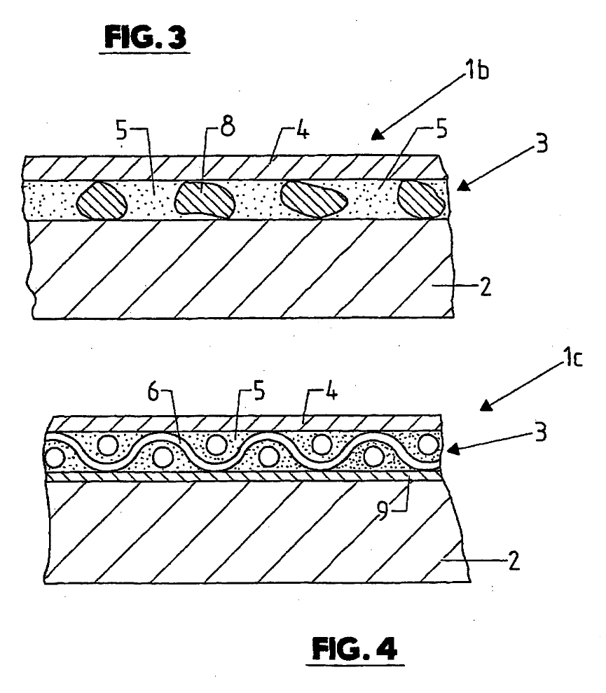

FIG. 3 shows as a further embodiment a substrate 1b, the insulating layer of which contains, in addition to the second, polymer component, as a spacer component or spacer a plurality of particles 8 made of an electrically conductive, inorganic, dimensionally stable material, for example particles made of glass, ceramic, e.g. Al₂O₃, Si₃N₄, AlN, BeO, SiC, BN or diamond. The volume of the insulating layer 3 not occupied by the particles 8 is again filled with the polymer material.

The substrate 1b or its insulating layer 3 is manufactured for example by applying the particles 8 forming the first component in combination with the polymer material forming the second component with a layer thickness that is approximately the same as the particles 8. Of course, there are also other possibilities for achieving the insulating layer 3 in this embodiment, for example by first applying a layer made of the polymer material to the base layer 2 and then for example by sprinkling and pressing the particles 8 into the polymer layer.

FIG. 4 shows as a further embodiment a partial view of a substrate 1c, which differs form the substrate 1 in that an intermediate layer made of a metallic oxide is provided between the insulating layer 3 and the base layer 2, and that this oxide is for example an oxide of the metal of the base layer 2 or an oxide of a different metal than the metal of the base layer 2. The intermediate layer 9 then serves for example as a further insulating layer for increasing the dielectric strength between the metallization 4 and the base layer 2 and/or as an adhesive layer for an improved bond of the insulating layer to the base layer without any appreciable effect on the thermal conductivity. A suitable material for the intermediate layer 9 is aluminum oxide, for example. The thickness of the intermediate layer is for example approximately between 0.5 and 80 μm. If the base layer 2 is made of aluminum, then it is also possible to achieve the intermediate layer 9 through anodizing.

It goes without saying that also the substrates 1a and 1b of FIGS. 2 and 3 can be designed with the intermediate layer 9 in a similar manner. Furthermore, it is possible of course to provide the respective base layer 2 on both sides with an insulating layer 3 and a metallization 4, for example also using an additional intermediate layer 9.

FIG. 5 shows in an enlarged view a partial cross section of a substrate 1d, which again features the base layer 2, which is provided on both surfaces with an insulating layer 3 and with a metallization 4, which is electrically separated from the base layer 2 by the insulating layer 3. The substrate 1d is shown in the area of a through-hole contact 10, which is formed by an opening 11 in the base layer 2. The insulating layer 3 extends with a section 3.1 also through the opening 11, i.e. also the inner surface of the opening 11 is covered by the section 3.1 of the insulating layer 3. The two metallizations 4 are connected with each other by means of a section 4.1, which covers the section 3.1 of the insulating layer 3 in the area of the opening 11.

In the depicted embodiment, the insulating layer 3 on the two surfaces of the base layer 2 consists of the two components, namely of the first spacer component and of the polymer material or the polymer component 5; although the spacer component in FIG. 5 is shown as a fabric 6, it can of course also be designed in another manner, for example as a fibrous web or as particles, etc. In the area of the opening 11, the spacer component 6 is missing in the depicted embodiment in the section 3.1 of the insulating layer 3, i.e. the section 3.1 of the insulating layer is made only of the insulating material, for example the polymer material.

The metallization 4, including the section 4.1, is manufactured in this embodiment for example by chemical and galvanic separation of metal, for example copper. The thickness of the metallization 4 in this embodiment is for example between 20 and 500 μm.

FIG. 6 again shows the substrate 1, however with the structured metallization forming the contact surfaces or strip conductors 12 on the side of the insulating layer 3 facing away from the base layer 2. An electric component 14, for example a power component (e.g. diode, transistor, thyristor, etc.) is fastened to the contact surfaces 13 in a suitable manner, e.g. by soldering or gluing with a conductive glue and is electrically connected with the strip conductors 12 in a suitable manner, e.g. through wire bonding. The structuring of the respective metallization for forming the strip conductors 12 and contact surfaces 13 is achieved using standard technologies, e.g. etching and masking technology.

FIG. 7 shows a module 15 with a closed housing 16 consisting of a lower housing section 16.1 and a housing cover 16.2. In the hermetically sealed interior 17, electric components 14 are provided through contact surfaces 13 forming a structured metallization, which (electric components) are then connected in a suitable manner with strip conductors 12 likewise formed by structuring of a metallization, e.g. connected by wire bonding or by directly connecting the respective module with its leads in a suitable manner, e.g. by soldering, to the respective strip conductor 12.

The strip conductors 12 and contact surfaces 13 are again provided on the insulating layer 3, which is designed in the same manner as described above for the substrates 1-1d, namely consisting at least of the first, spacer component and the second, polymer component. The insulating layer 3 is connected with its side facing away from the strip conductors 12 and contact surfaces 13 to the inner bottom surface of the housing sections 16.1, which in this embodiment forms the base layer corresponding to the base layer 2 and is designed in the same manner as described above for the base layer 2. The interior 17 of the housing 16 is hermetically sealed toward the outside using a seal 18, for example, and is closed tightly by the cover 16.2. The outer connections 19 emerging from the housing 16 are sealed and electrically insulated.

FIG. 8 shows an enlarged partial view of a module 15a, which differs from the module 15 essentially in that the strip conductors 12 and contact surfaces 13 are not provided on an insulating layer 3 applied directly to the inner bottom surface of the trough-shaped housing element 16.1, but rather on a separate substrate, for example on the substrate 1, which is inserted in the interior 17 of the housing 16 and fixed there on the bottom of the lower housing element 16.1 in a suitable manner, namely by means of an intermediate or fixing layer 20. The latter is then designed for example corresponding to the insulating layer 3, or is formed for example by a thermally conductive glue.

Other possibilities for fixing the substrate 1 on the inside of the housing element 16.1 are also possible or applicable. For example, it is also possible to design the substrate bearing the components 14 in deviation from the FIGS. 1-4, so that a further insulating layer 3 with a metallization 4 is provided also on the bottom surface of the metallic base layer 2 facing away from the strip conductors 12 and contact surfaces 13, which (further insulating layer) is then connected using a suitable soldering technique or a thermally conductive glue to the bottom of the housing element 16.1, as depicted schematically in FIG. 9.

FIG. 10 shows as a further embodiment of the invention a module 15b, which differs from the module 15 essentially only in that the housing element 16.1 is manufactured on its outer surface facing away from the interior 17 as a cooler element made as one piece with a plurality of cooling fins 21. In the further embodiment depicted in FIG. 11, the cooling fins 21 are part of a cooling element 22 connected for example also thermally with the outer, in FIG. 11 bottom, surface of the housing element 16.1, and for this purpose a layer 23 consisting of a thermal compound is provided.

All embodiments described above have in common that the respective insulating layer 3 is formed by at least two components, namely by the first, spacer component and by the second, polymer component. The spacer component is made of a dimensionally stable, preferable inorganic material, e.g. fiber material, fabric, fibrous web or particles. The polymer component is for example a cross-linked material, such as epoxy resin or thermoplast or aramide.

To increase the thermal conductivity, it is also possible for the polymer component to contain an additive of at least one electrically non-conductive and highly thermally conductive material, for example ceramic particles; however, the particles are then considerably smaller than the thickness of the insulating layer or smaller than the hollow spaces in the spacer component.

The material for the filling component, in particular the material of the particles forming said components has a thermal conductivity greater than 20 W/K. Suitable particles for the filling component are such particles made of glass, ceramic, e.g. Al₂O₃, Si₃N₄, AlN, BeO, SiC, BN or diamond. The materials of these particles can also be used in a much smaller form or as an additive or filling of the polymer component.

The thickness of the respective insulating layer 3 is for example between 20 and 150 μm. The thickness of the metallic base layer 2 is for example between 0.2 and 10 mm.

The metallization 4 is applied for example as a foil or is produced through chemical and galvanic separation of a metal, for example of copper. The thickness of the metallization is for example between approx. 20 and 500 μm.

The polymer component is selected so that the thermal stability of the insulating layer 3 is greater than 110° C., i.e. the thermal deformation point of the insulating layer is above 110° C.

The invention was described above based on exemplary embodiments. It goes without saying that numerous modifications and variations are possible without abandoning the underlying inventive idea upon which the invention is based.

It was assumed above that the spacer component is made of an inorganic material. Generally it is also possible to use an organic material for the spacer component, for example a duroplastic material or a thermoplastic material, for example polyamide, but in any case a material with a temperature stability or a deformation point which is significantly above the processing temperature for the manufacture and/or processing of the substrate and also significantly above the temperature stability or the thermal deformation point of the further, polymer component. Also in this embodiment the spacer component is then for example a fabric, a fibrous web and/or is formed by particles made of the aforementioned materials.

### REFERENCE LIST

1, 1a, 1b, 1c, 1d substrate
2 base layer
3 insulating layer
4 metallization
5 first distance-maintaining component in the form of a fabric
6 second polymer component
7 fibrous web
8 particles
9 intermediate layer
10 through-hole contact
11 opening in base layer for through-hole contact
12 strip conductor
13 contact surface
14 component
15, 15a, 15b, 15c module
16 housing
16.1, 16.2 housing section
17 interior of housing
18 seal
19 external connections of module
20 fixing layer
21 cooling fin
22 cooler
23 layer of thermal compound

What is claimed is:

1. A substrate with a metallic base or support layer, with at least one insulating layer provided on a surface or surface side of the base layer, the insulating layer being manufactured using a polymer material or a polymer component, and with a metallization, which is provided on at least one section of the insulating layer and is electrically separated by this insulating layer from the base layer, wherein the insulating layer comprises at least one further spacer component, which as a distance-maintaining component defines a thickness of the at least one insulating layer and is made of an electrically non-conductive stable or dimensionally stable material.

2. The substrate according to claim 1, wherein the spacer component is formed by particles (8) from the dimensionally stable inorganic material.

3. The substrate according to claim 1, wherein the spacer component is made of diamond, glass, or a ceramic, selected from Al₂O₃, Si₃N₄, AlN, BeO, SiC, or BN.

4. The substrate according to claim 1, wherein the spacer component is made of fibers from a dimensionally stable inorganic material.

5. The substrate according to in that claim 1, wherein the spacer component is a fibrous web from a dimensionally stable inorganic material.

6. The substrate according to claim 1, wherein the spacer component is made of an inorganic, dimensionally stable and electrically non-conductive material, which has a temperature liquidity or a thermal deformation point that is significantly higher than a process temperature during manufacture and/or utilization.

7. The substrate according to claim 6, wherein the material of the spacer component is a duroplastic material or a polyamide.

8. (canceled)

9. The substrate according to claim 1, wherein the polymer component is a cross-linked synthetic material, a duroplastic or a thermoplastic polymer.

10. The substrate according to claim 1, wherein the polymer component contains aramide.

11. The substrate according to claim 1, wherein the polymer component contains at least one filler made of an electrically non-conductive material with good thermal conductivity.

12. The substrate according to claim 11, wherein the at least one filler has a particle size that is smaller than a thickness of the insulating layer.

13. The substrate according to claim 11, wherein the at least one filler is formed from an inorganic material, from ceramic particles with a thermal conductivity greater than 20 W/K.

14. The substrate according to claim 13, wherein the at least one filler is formed from particles made of Al₂O₃, Si₃N₄, AlN, BeO, SiC or BN.

15. The substrate according to claim 11, wherein the at least one filler of the polymer component is formed from particles made of glass or diamond.

16. (canceled)

17. The substrate according claim 1, wherein a metal of the metallization or the base layer is copper, aluminum, a copper alloy or an aluminum alloy.

18. (canceled)

19. The substrate according to claim 1, wherein the base layer has a thickness between 0.2 and 10 mm.

20. The substrate according to claim 1, wherein the insulating layer (3) has a thickness between 20 and 150 μm.

21. The substrate according to claim 1, wherein an intermediate layer made of an electrically insulating material, a metal oxide, or aluminum oxide, the intermediate layer is provided between the base layer and the at least one insulating layer.

22. The substrate according to claim 21, wherein the metal oxide forming the intermediate layer is an oxide of the metal of the base layer (2).

23. The substrate according to claim 21, wherein the metal oxide forming the intermediate layer is an oxide of a different metal than the metal of the base layer.

24. The substrate according to claim 21, wherein for a base layer made of aluminum, the intermediate layer is manufactured by anodizing.

25. The substrate according claim 1, wherein the metallization has a thickness between 20 and 500 μm.

26. The substrate according to claim 1, wherein the intermediate layer (9) has a thickness between 0.5 and 80 μm.

27. The substrate according to claim 1, wherein the polymer component is selected so that the thermal stability of the at least one insulating layer is greater than 110° C.

28. The substrate according to claim 1, wherein the at least one insulating layer with a metallization, is provided on both surfaces or surface sides of the base layer.

29. The substrate according to claim 1, further comprising at least one through-hole contact in the area of an opening of the base layer, and the insulating layer or a section of said insulating layer is also formed in the area of the opening.

30. The substrate according to claim 29, wherein the insulating layer does not have the spacer component in the area of the opening.

31. The substrate according to claim 21, wherein the intermediate layer provided between the insulating layer and the base layer also extends to the area of the opening.

32. The substrate according to claim 1, wherein the substrate is part of a module, which has at least one component on the structured metallization in a interior of a housing provided on the at least one insulating layer to form strip conductors and/or contact surfaces.

33. The substrate according to claim 32, wherein the insulating layer is provided on a surface of a housing element serving as a base layer.

34. The substrate according to claim 32, wherein the at least one insulating layer with strip conductors and/or contact surfaces produced from the at least one metallization by structuring is provided on the metallic base layer, and that the base layer is connected at least thermally with a housing element of the module.

35. The substrate according to claim 32, wherein the housing or a housing element of the module is manufactured as one piece with cooling fins or is connected with a cooling element comprising said cooling fins.
